(19) United States
(12) Patent Application Publication
(10) Pub. No.: US 2025/0178282 A1
(43) Pub. Date: Jun. 5, 2025

(54) SMART TRANSFER SYSTEM AND METHOD FOR PERFORMING 3D PRINTING OUTPUT POST-PROCESSING AND LOADING PROCESSES

(71) Applicant: ELECTRONICS AND TELECOMMUNICATIONS RESEARCH INSTITUTE, Daejeon (KR)

(72) Inventors: Chang Beom KIM, Daejeon (KR); Hyun Chul KANG, Daejeon (KR); Min Gi KIM, Daejeon (KR); Eun Seo LEE, Daejeon (KR)

(21) Appl. No.: 18/776,627

(22) Filed: Jul. 18, 2024

(30) Foreign Application Priority Data
Dec. 4, 2023 (KR) 10-2023-0173820

(51) Int. Cl. B29C 64/379; B29C 64/35; B33Y 40/20

(52) U.S. Cl. CPC B29C 64/379; B29C 64/35; B33Y 40/20

(57) ABSTRACT

The present invention relates to a smart transfer system and method for performing three-dimensional (3D) printing output post-processing and loading processes, and the smart transfer system includes a transfer device configured to transfer a basket accommodating an output of a 3D printer, a plurality of process modules configured to perform cleaning, rinsing, drying, and post-curing processes on the output, and a control device configured to set work to be performed on the basis of information about the output, set a work path of the plurality of process modules according to the work, and control the transfer device to move along the work path.

### CROSS-REFERENCE TO RELATED APPLICATION

This application claims priority to and the benefit of Korean Patent Application No. 10-2023-0173820, filed on Dec. 4, 2023, the disclosure of which is incorporated herein by reference in its entirety.

### BACKGROUND

### 1. Field of the Invention

The present invention relates to a smart transfer system and method for performing three-dimensional (3D) printing output post-processing and loading processes, in which a post-processing process and a loading process are performed on a 3D printing output using an autonomous mobile robot.

### 2. Description of Related Art

Three-dimensional (3D) printing technology is being spotlighted as a next-generation cutting-edge producing technology as it can rapidly and conveniently produce items of various shapes. In particular, printing using a photocuring producing method is a method of rapidly producing outputs by curing a surface of a resin contained in a tank with a specific frequency laser, and has an advantage of a smooth and precise surface of the output.

However, in the printing using the photocuring producing method, due to the characteristics of the printing method, a large amount of residual resin remains on the surface and inside the output after the output is produced, and thus it is necessary to perform a post-processing process for the residual resin removal operation.

Conventional methods for removing residual resin include ultrasonic cleaning, rotary cleaning, and underwater cleaning, but in most conventional methods, post-processing work is manually performed with direct intervention of human labor.

Further, in the conventional method for removing residual resin, when equipment is available, the post-processing work is performed by controlling the equipment by setting the equipment's parameter settings in detail on the basis of the operator's experience.

Post-processing work using equipment is performed by individually operating the equipment manually with human intervention, and the entire post-processing process (cleaning, rinsing, drying, and post-curing), including removal of residual resin, is performed by the operator manually transporting the output from start to finish.

Further, conventional post-processing equipment is a combination of a single 3D printer and post-processing modules with an integrated structure, and only a serial process post-processing method is possible, resulting in slow production speed and low efficiency in rapidly processing various outputs.

Therefore, there is a need for a method of rapidly post-processing, transferring, and loading various types of 3D printing outputs by minimizing operator intervention and accelerating the process.

The related art of the present invention is disclosed in Korean Laid-open Patent Application No. 10-2023-0125047 (Published on Aug. 28, 2023).

### SUMMARY OF THE INVENTION

The present invention is directed to providing a smart transfer system and method for performing three-dimensional (3D) printing output post-processing and loading processes, in which an autonomous robot is used to continuously and effectively transfer outputs to individual processes or between processes and automatically transfers the outputs to a loading module in order to perform supply, cleaning, rinsing, drying, and post-curing, which are basic post-processing processes for 3D printing output.

According to an aspect of the present disclosure, there is provided a smart transfer system for performing 3D printing output post-processing and loading processes, which includes a transfer device configured to transfer a basket accommodating an output of a 3D printer, a plurality of process modules configured to perform cleaning, rinsing, drying, and post-curing processes on the output, and a control device configured to set work to be performed on the basis of information about the output, set a work path of the plurality of process modules according to the work, and control the transfer device to move along the work path.

The control device may receive the information about the output from the 3D printer, set the work path to perform at least one of the cleaning, rinsing, drying, and post-curing processes according to the information about the output, and set a work variable for the work to be performed to control the plurality of process modules.

The control device may communicate with the plurality of process modules, transmit the work variable to the plurality of process modules, and monitor operational states of the plurality of process modules.

The control device may communicate with the transfer device, track a location of the transfer device, and store data received from the transfer device.

When the control device transfers a plurality of outputs using a plurality of transfer devices, the control device may set a schedule for preventing collisions between the plurality of transfer devices and operating the plurality of process modules.

The plurality of process modules may further include a vertical movement module that moves the transfer device up and down.

The smart transfer system may further include a loading module configured to load the output, and when the post-processing process is completed, the transfer device may move to the loading module and move the basket accommodating the output to the loading module.

The smart transfer system may further include a basket supply module including the basket, and the transfer device may load the basket, then move to the basket supply module, mount a new basket on the basket supply module, and accommodate a new output in the new basket.

When the transfer device stops at any one process module of the plurality of process modules, the transfer device may move the basket downward so that the output accommodated in the basket is introduced into a work bath provided inside the process module.

In a state in which the output is introduced into the work bath of the process module, the transfer device may rotate in place around the process module through a rotation motor so that the output rotates together with the basket.

In a state in which the output is introduced into the work bath of the process module, the transfer device may rotate in place around the process module through a rotation motor so that the output rotates together with the basket.

According to another aspect of the present disclosure, there is provided a smart transfer device for performing 3D printing output post-processing and loading processes, which includes a basket-fixing part into which a basket accommodating an output is inserted, a basket-fixing electromagnet that is provided above the basket-fixing part and fixes the basket, a vertical drive motor configured to move the basket up and down, a position sensor configured to detect a location of the basket, a communication device configured to communicate with a control device and a process module, and a main processor configured to communicate with a control device, control the smart transfer device to travel along a specified work path, and allow the basket to be moved up and down through the vertical drive motor.

The main processor may allow the basket-fixing part to be moved downward by an operation of the vertical drive motor and allow the basket to be introduced into the process module together with the output so that a post-processing process is performed on the output.

The smart transfer device may further include a rotation motor installed on a wheel, and the main processor may drive the rotation motor, and control the main body to rotate in place around the process module so that the basket rotates inside the process module together with the output.

According to still another aspect of the present disclosure, there is provided a smart transfer method for performing 3D printing output post-processing and loading processes, which includes moving a transfer device equipped with a basket to a supply module and accommodating, by the transfer device, an output generated from a 3D printer in the basket, receiving, by a control device, data on the output from the 3D printer, setting, by the control device, post-processing work to be performed on the basis of the data on the output and setting a work path of the transfer device for the post-processing work, and moving the transfer device along the work path, stopping at any one process module of a plurality of process modules, and performing, by the transfer device, a post-processing process on the output.

The smart transfer method may further include, when the post-processing process is completed, moving the transfer device to a loading module and loading, by the transfer device, the basket accommodating the output into the loading module.

The smart transfer method may further include setting, by the control device, a work variable for a process module to perform the post-processing work, transmitting, by the control device, the work variable to the process module, and when the transfer device stops at the process module, operating, by the process module, according to the set work variable and post-processing the output.

The performing of the post-processing process may further include, when the transfer device stops at any one process module of the plurality of process modules, moving the basket downward and introducing the output accommodated in the basket into a work bath provided inside the process module.

The performing of the post-processing process may further include, in a state in which the output is introduced into the work bath of the process module, rotating the transfer device in place around the process module through a rotation motor so that the output rotates together with the basket.

In the setting of the work path of the transfer device, when the transfer device is provided as a plurality of transfer devices, the control device may set a plurality of work paths to prevent collisions between the plurality of transfer devices and set a schedule for operating the plurality of process modules.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram illustrating a configuration of a smart transfer system for performing three-dimensional (3D) printing output post-processing and loading processes according to an embodiment of the present invention;

FIG. 2 is a block diagram briefly illustrating the configuration of the smart control device for performing the 3D printing output post-processing and loading processes according to an embodiment of the present invention;

FIG. 3 is a flowchart illustrating a smart transfer method for performing 3D printing output post-processing and loading processes according to an embodiment of the present invention;

FIG. 4 is a diagram referenced to describe the smart transfer system for performing the 3D printing output post-processing and loading processes according to an embodiment of the present invention;

FIGS. 5A and 5B are a set of diagrams illustrating another example of the smart transfer system for performing the 3D printing output post-processing and loading processes according to an embodiment of the present invention;

FIGS. 6A and 6B are a set of diagrams illustrating a smart transfer device for performing 3D printing output post-processing and loading processes according to an embodiment of the present invention;

FIG. 7 is a diagram illustrating a basket of a smart transfer device according to an embodiment of the present invention;

FIG. 8 is a set of diagrams illustrating an example in which a basket of a smart transfer device according to an embodiment of the present invention is mounted;

FIGS. 9A and 9B are a set of diagrams illustrating a location of a basket for processing work of a smart transfer device according to an embodiment of the present invention;

FIGS. 10A to 10C are a set of diagrams referenced to describe a rotational operation of the smart transfer device according to an embodiment of the present invention;

FIG. 11 is a diagram referenced to describe an output reception method of the smart transfer device according to an embodiment of the present invention;

FIG. 12 is a diagram referenced to describe processing work of the smart transfer device according to an embodiment of the present invention;

FIG. 13 is a diagram referenced to describe a work path of the smart transfer device according to an embodiment of the present invention;

FIG. 14 is a diagram illustrating a configuration of a smart transfer system in which the arrangement of post-processing process modules according to an embodiment of the present invention has been changed;

FIG. 15 is a diagram illustrating a configuration of a smart transfer system having a plurality of work paths according to an embodiment of the present invention;

FIGS. 16A and 16B are a set of diagrams illustrating a method of loading an output in the smart transfer device according to an embodiment of the present invention; and

FIG. 17 is a diagram illustrating a method of mounting a basket in the smart transfer device according to an embodiment of the present invention.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, embodiments of a smart transfer system and method for performing three-dimensional (3D) printing output post-processing and loading processes according to the present invention will be described.

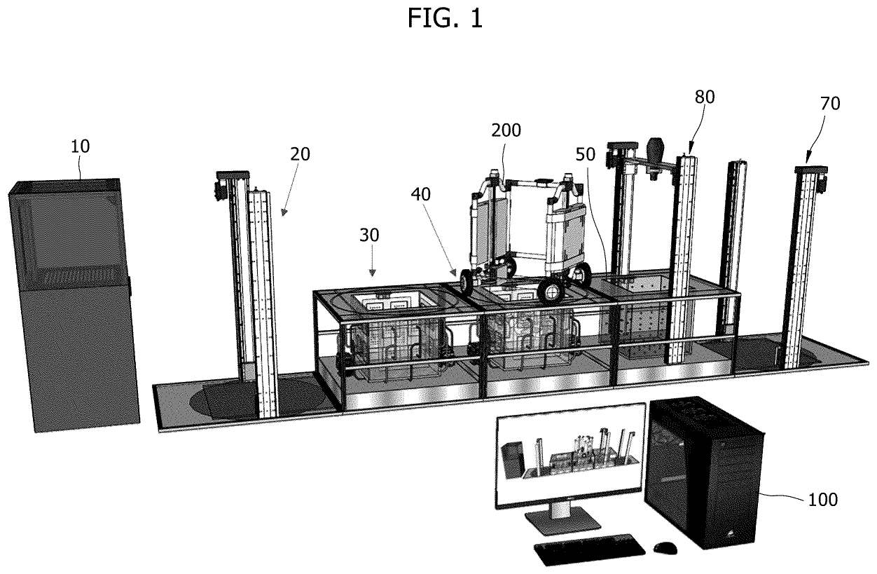

FIG. 1 is a diagram illustrating a configuration of a smart transfer system for performing 3D printing output post-processing and loading processes according to an embodiment of the present invention.

Referring to FIG. 1, the smart transfer system for performing the 3D printing output post-processing and loading processes according to the embodiment of the present invention includes a 3D printer 10, a supply module 20, a cleaning module 30, a rinsing module 40, a post-curing module 50, a drying module 60, a vertical movement module 70, a transfer device 200, and a control device 100.

Further, the smart transfer system of the present invention further includes a loading module (not illustrated) and a basket supply module (not illustrated) for loading outputs.

The 3D printer 10 generates 3D outputs.

A 3D printer 10 with a photocuring producing method cures a surface of a resin contained in a tank with a specific frequency laser to produce an output. Meanwhile, a stack-type 3D printer 10 may produce a 3D object by layering materials on the basis of a 3D drawing.

The cleaning module 30, the rinsing module 40, the post-curing module 50, and the drying module 60 are modules for performing post-processing processes on an output. The cleaning module 30 may remove and clean foreign substances on the output, the rinsing module 40 may rinse the output, and the post-curing module 50 may cure the output once again. The drying module 60 dries the output.

The supply module 20 allows the output of the 3D printer 10 to be accommodated in the transfer device 200.

Further, the supply module 20 may move the transfer device 200 in a vertical direction so that the transfer device 200 may move on the top of the cleaning module 30.

The vertical movement module 70 may move the transfer device 200 located at the top of any one module (e.g., the post-curing module 50) to a bottom surface. The vertical movement module 70 may move the transfer device 200 located on the bottom surface upward to move the transfer device 200 to the top of any one of the plurality of process modules.

The transfer device 200 performs the post-processing processes on the output while moving between the modules in a state in which the output is accommodated in a basket. At least one of an automated guided vehicle (AGV) and an autonomous mobile robot (AMR) may be used as the transfer device 200. In addition, the transfer device 200 may be applied to any device as long as it can accommodate the basket and drive autonomously.

The transfer device 200 may autonomously move on the top of the cleaning module 30, the rinsing module 40, and the post-curing module 50. The transfer device 200 may perform work set by the control device 100 and move along a specified work path.

The transfer device 200 moves the basket accommodating the output up and down to allow the output to move into the cleaning module 30, the rinsing module 40, and the post-curing module 50, and when the work in any one module is completed, the transfer device 200 repeats moving the basket upward again and moving the basket to a next module.

When the post-processing processes for the output are completed, the transfer device 200 moves to the loading module and loads the output into the loading module.

The control device 100 controls the operations of a plurality of modules including the cleaning module 30, the rinsing module 40, the post-curing module 50, and the drying module 60. Further, the control device 100 may control the operations of the supply module 20 and the vertical movement module 70.

The control device 100 may communicate with the transfer device 200 and the plurality of process modules in a wireless communication manner.

The control device 100 receives information about the output from the 3D printer 10, sets work to be performed among a plurality of post-processing processes in response to the output, and sets a work path of the transfer device 200 in response to the set work.

Further, the control device 100 may set operation schedules for the transfer device 200 and the plurality of process modules.

The control device 100 may track the location of the transfer device 200 and control each module to operate based on signals received from the plurality of process modules.

When the output is accommodated and loaded into the loading module by the transfer device 200, the control device 100 may update and store a record of the output. The control device 100 may match and store information about the location where the output is loaded and the performed post-processing processes.

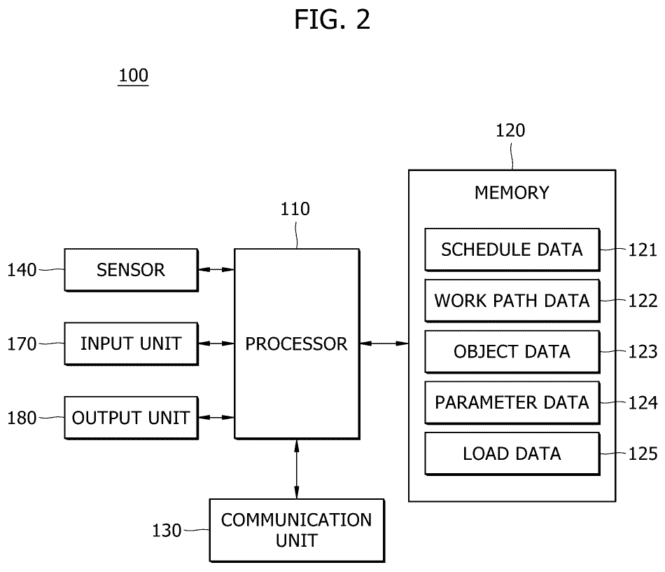

FIG. 2 is a block diagram briefly illustrating the configuration of the smart control device for performing the 3D printing output post-processing and loading processes according to the embodiment of the present invention.

Referring to FIG. 2, the control device 100 may include an input unit 170, an output unit 180, a sensor 140, a memory 120, a communication unit 130, and a processor 110.

The memory 120 may store schedule data 121, work path data 122, object data 123, parameter data 124, and load data 125.

The schedule data 121 may include information about the schedules for the transfer device 200 and the plurality of process modules. The work path data 122 may include the type of work to be performed on the output and data on a movement path of the transfer device 200 according to the type of work.

The object data 123 includes information about the output. For example, the object data 123 may include information about an identification (ID), a volume, a mass, a thickness, and a slicing layer of the output.

The parameter data 124 may include operation setting information for cleaning, rinsing, drying, and post-curing in response to the information about the output. For example, the parameter data 124 may include setting information such as an operating time, a temperature, an intensity, and the number of process repetitions according to the operation of each module. The settings of the parameter data 124 may be changed depending on the output. The load data 125 may include information about the location where the output is loaded.

The memory 120 may store control data for controlling the operations of the plurality of process modules, and location data for storing location information of the plurality of process modules.

Further, the memory 120 may store data on at least one of a module control algorithm, a position tracking algorithm, a route setting algorithm, a post-processing process control algorithm, and a loading information management algorithm for controlling the respective operations of the plurality of process modules.

The memory 120 may include storage devices such as non-volatile memories, such as a random access memory (RAM), a read-only memory (ROM), an electrically erased programmable ROM (EEPROM), etc., a flash memory, and the like.

The input unit 170 may include at least one input device among a switch, a button, and a touch pad.

The input unit 170 may receive a command to initiate the performance of post-processing processes and the transfer of outputs, and apply the command to the processor 110. Further, the input unit 170 may receive the information about the output, and data for adding or modifying the work path of the transfer device.

The output unit 180 may integrate at least one of a speaker, an operating lamp, and a display to output an operational state of the system.

The output unit 180 may output operational states of the plurality of process modules, the current location of the transfer device 200, and the information about the output on which the post-processing work is currently being performed. When work is performed on a plurality of outputs, the output unit 180 may output the work progress status of each output.

When an error occurs in any one task, the output unit 180 may output a warning about the error.

The communication unit 130 communicates with the cleaning module 30, the rinsing module 40, the post-curing module 50, and the drying module 60 to transmit or receive information about the ongoing work. The communication unit 130 may communicate with the transfer device 200 to share the current location.

The communication unit 130 may communicate with the 3D printer 10 to receive the information about the output, and communicate with the supply module 20, the vertical movement module 70, and the loading module.

Further, the communication unit 130 may communicate with an external terminal (not illustrated), a server (not illustrated), and a database (not illustrated) through a communication network.

The communication unit 130 may communicate through at least one of short-range communication, such as Ethernet, Wi-Fi, Bluetooth, etc., mobile communication, and serial communication.

The processor 110 may include at least one microprocessor and operate based on data and algorithm data that are stored in the memory 120.

When the processor 110 receives data on the output of the 3D printer through the communication unit 130, the processor 110 may select the type of post-processing work to be performed on the basis of the data on the output, and accordingly, set the work path of the transfer device 200. Further, the processor 110 may set parameters for the plurality of process modules on the basis of the data on the output.

For example, the processor 110 may set an operating time, a temperature, an intensity, the number of process repetitions, etc. for each cleaning, rinsing, drying, and post-curing task on the basis of the information about the ID, the volume, the mass, the thickness, and the slicing layer of the output.

The processor 110 may set some work not to be performed in response to the output.

The processor 110 may communicate with the plurality of process modules through the communication unit 130 to monitor the working status, and track the location of the transfer device 200.

When the post-processing work is completed and the transfer device 200 loads the output into the loading module, the processor 110 receives loading location information and stores the loading location information in the memory 120.

When work is simultaneously performed on a plurality of outputs, the processor 110 may set schedules for the plurality of process modules and the transfer device to set the plurality of outputs to be processed simultaneously. Further, the processor 110 may set different work paths for the plurality of outputs to prevent collisions between the transfer devices 200.

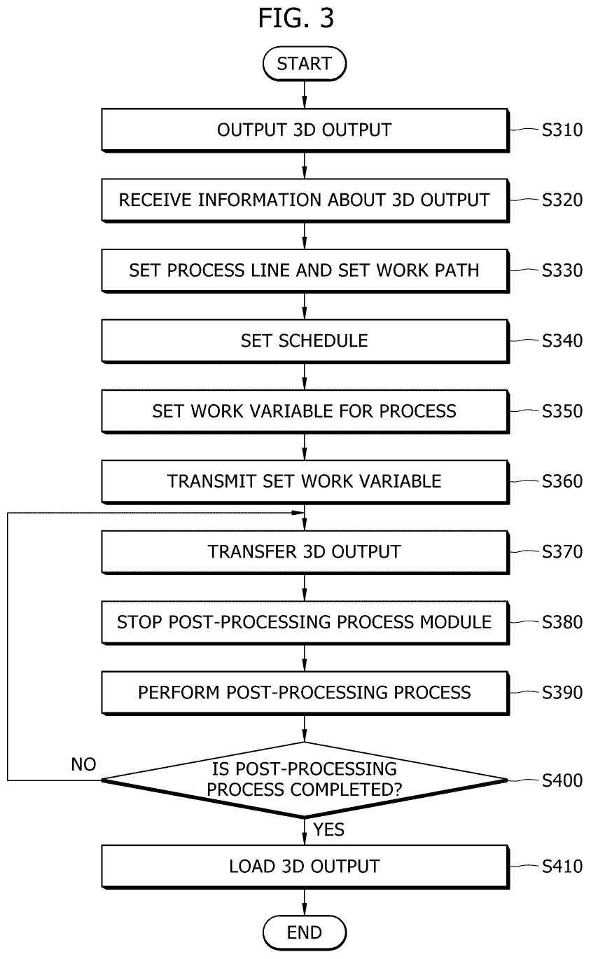

FIG. 3 is a flowchart illustrating a smart transfer method for performing 3D printing output post-processing and loading processes according to an embodiment of the present invention.

Referring to FIG. 3, in the smart transfer system of the present invention, when the 3D printer 10 generates an output (S310), the control device 100 communicates with the 3D printer 10 through the communication unit 130 to receive information about the output (S320).

The control device 100 may transmit a start signal to the transfer device 200 to start work on a new output.

When the transfer device 200 receives the start signal, the transfer device 200 loads a new basket and moves to the supply module 20 so that the output is accommodated in the basket.

The control device 100 sets the type of work to be performed on the output and sets a work path to move to a process line corresponding to the set type of work (S330). Further, the control device 100 may set schedules for a plurality of process modules and the transfer device 200 (S340).

In some cases, the transfer device 200 may receive the information about the output, set the type of work by itself, and set the work path.

The control device 100 transmits the set work and the corresponding work path to the transfer device 200.

Further, the control device 100 sets work variables for each process line according to the set type of work (S350). For example, the control device 100 may set an operating time, a temperature, an intensity, and the number of process repetitions as work variables for each selected task from among cleaning, rinsing, drying, and post-curing work.

The control device 100 transmits the set work variables to each module (S360).

For example, when cleaning work is required for the output, the control device 100 sets a work variable for cleaning and transmits the work variable to the cleaning module 30 to control the cleaning module 30 to operate according to the settings.

Meanwhile, the transfer device 200 transfers the output accommodated in the basket along the received work path (S370). The transfer device 200 may move vertically through the supply module 20 to the top of any one module and then move along a specified work path.

The transfer device 200 moves to a specified process line and stops according to the set type of work (S380).

The transfer device 200 receives information about each module while moving on the top of the plurality of process modules to check whether the module is a module of the specified process line, and stops at the corresponding module when it is checked that the module is the module of the specified process line.

The transfer device 200 changes the location of the basket in response to the set work so that specified work (a post-processing process) is performed. The transfer device 200 waits until the work is completed.

The module of the process line on which the transfer device 200 stops performs a post-processing process according to the work variables set by the control device 100 (S390).

For example, when cleaning work is set for the output, the transfer device 200 moves to the cleaning module 30, stops, and moves the basket downward so that the output is introduced into the cleaning module 30.

The transfer device 200 maintains a standby state while the cleaning work is performed on the output.

When the work is completed, the module transmits a signal for work completion to the transfer device 200.

The transfer device 200 checks whether all the specified work is completed (S400), and when there is remaining work, the transfer device 200 moves to a next module along the work path and then performs a next task.

For example, when the transfer device 200 receives a signal for completion from the cleaning module 30, the transfer device 200 moves the basket upward and then moves to a module that will perform a next task, along the work path.

The control device 100 may track the location of the transfer device 200 and monitor the work progress status.

Meanwhile, when the work related to the post-processing process is completed (S400), the transfer device 200 moves to the vertical movement module 70, moves downward, and travels on the bottom surface to move to the loading module.

The transfer device 200 loads the basket accommodating the output into the loading module (S410).

The transfer device 200 may transmit information about the loaded output, a loading time, and a location to the control device 100.

The control device 100 stores the work information of the post-processing process for the output, data on the loading location, and the like in the memory 120.

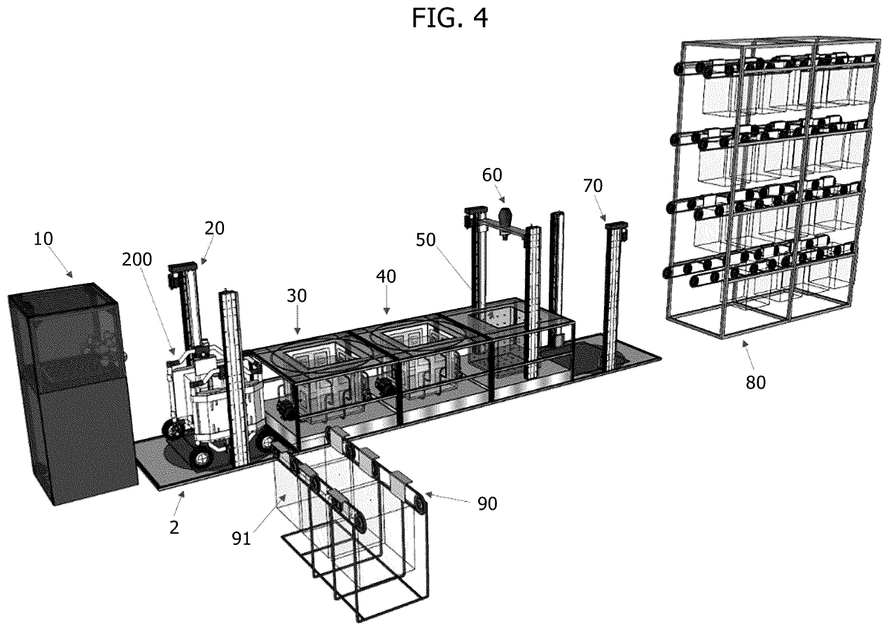

FIG. 4 is a diagram referenced to describe the smart transfer system for performing the 3D printing output post-processing and loading processes according to an embodiment of the present invention.

Referring to FIG. 4, the smart transfer system includes the 3D printer 10, the supply module 20, the cleaning module 30, the rinsing module 40, the post-curing module 50, the drying module 60, the vertical movement module 70, the transfer device 200, and the control device 100 as described above, and also includes a loading module 80 and a basket supply module 90.

The loading module 80 is configured to load baskets accommodating outputs 1. The loading module may be formed to have a plurality of layers.

The basket supply module 90 includes baskets 91 to be mounted on the transfer device 200.

The transfer device 200 may move to the basket supply module 90 and mount a new basket 91 on the basket supply module 90.

When the output 1 supplied from the supply module 20 is accommodated in the basket 91, the transfer device 200 moves to the top of the module through a vertical movement device of the supply module 20 and then moves between the modules along a specified work path so that post-processing work is performed on the output 1.

The modules for each process line for post-processing processes are each independently divided into areas and perform individually specified work.

The control device 100 selects a post-processing process to be performed according to the output and sets work, and the transfer device 200 moves between the modules in response to the set work so that the post-processing process is performed on the output.

When the post-processing process is completed, the transfer device 200 moves to a bottom surface through the vertical movement module 70, then moves to the loading module 80, and loads the basket 91 containing the output 1 into the loading module 80.

The transfer device 200 may move to the basket supply module 90, mount a new basket 91 on the basket supply module 90, and transfer a next output to the new basket 91.

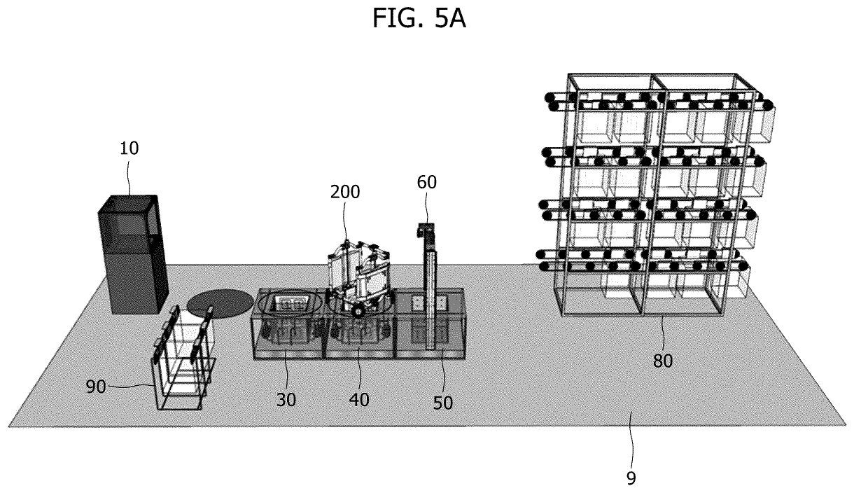

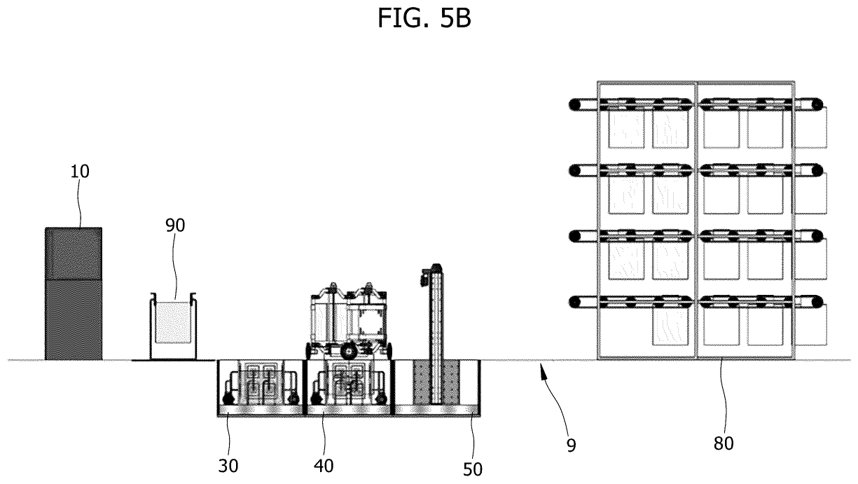

FIGS. 5A and 5B are a set of diagrams illustrating another example of the smart transfer system for performing the 3D printing output post-processing and loading processes according to an embodiment of the present invention.

Referring to FIGS. 5A and 5B, a plurality of process modules for performing post-processing processes may have upper portions formed to have the same height as a bottom surface. The modules may have a work space formed in a lower portion of a bottom surface 9.

Accordingly, the transfer device 200 may move between the modules along a work path without using a separate vertical movement module.

The transfer device 200 moves between the modules while traveling on the bottom surface 9 and stops at the module corresponding to specified work. The transfer device 200 moves the basket 91 accommodating the output 1 downward and then waits. In this case, the module performs the post-processing work on the output introduced into the module on the basis of set work variables.

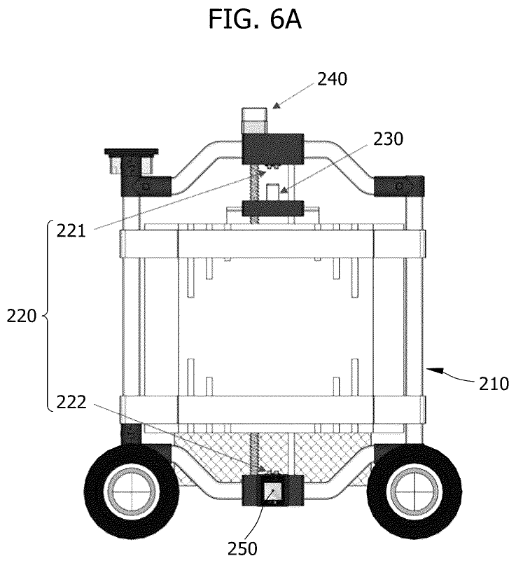

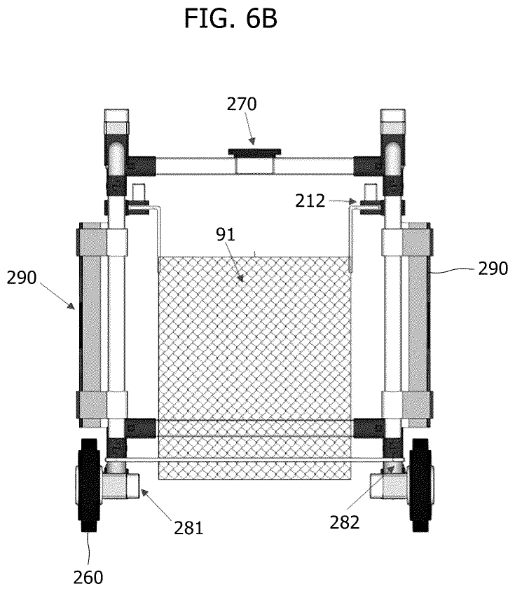

FIGS. 6A and 6B are a set of diagrams illustrating a smart transfer device for performing 3D printing output post-processing and loading processes according to an embodiment of the present invention.

Referring to FIGS. 6A and 6B, a transfer device 200 has wheels 260 mounted at a lower portion thereof and a basket 91 mounted at a central portion thereof.

The transfer device 300 may include a main body 210, an upper position sensor 221, a lower position sensor 222, a vertical drive motor 240, a basket-fixing electromagnet 230, batteries 290, communication devices 250 and 270, basket-fixing parts 212, driving motors 281, and rotation motors 282.

Further, the transfer device 300 may include a main processor (not illustrated) that controls the driving motor 281 to travel along a work path, controls the rotation motor 282 to change the direction of rotation, checks the location, and controls the rotation motor 282 to stop at a specific process module.

The batteries 290 are installed on both side surfaces of the main body 210 and provide energy for movement and operation of the main body 210.

The vertical drive motor 240 provides power to move the basket 91 vertically.

The driving motors 281 provide power to rotate the wheels 260 and move the main body 210.

The rotation motors 282 generate rotational force so that the main body 210 rotates left or right.

The basket-fixing parts 212 may be fitted into an upper end portion of the basket 91. The basket-fixing electromagnet 230 fixes the basket 91 fitted into the basket-fixing parts 212 using magnetic force.

The upper position sensor 221 and the lower position sensor 222 are installed at upper and lower portions of the main body 210, respectively, to recognize the location of the basket 91. The upper position sensor 221 and the lower position sensor 222 may recognize the location of the basket 91 in each of a plurality of process modules, a loading module, and a vertical movement module.

The upper position sensor 221 and the lower position sensor 222 may detect the location of the basket 91. Proximity sensors may be used as the upper position sensor 221 and the lower position sensor 222.

The communication devices 250 and 270 may be provided on the upper and lower portions of the main body 210, respectively. The communication devices 250 and 270 may receive information about the output 1 and communicate with the plurality of process modules and the control device 100.

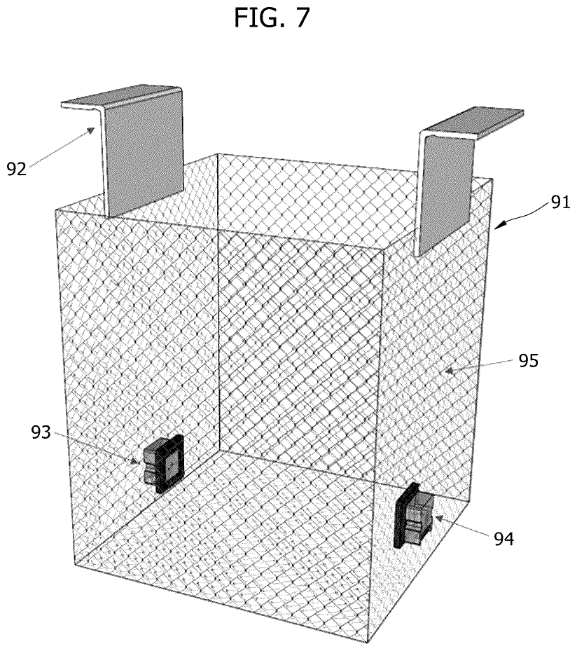

FIG. 7 is a diagram illustrating a basket of a smart transfer device according to an embodiment of the present invention.

Referring to FIG. 7, a basket 91 may be mounted on the transfer device 200.

The basket 91 may be configured in the form of a quadrangular box with a mesh 95.

The basket 91 may be formed in a mesh structure so that an output accommodated therein can be easily checked and the cleaning solution flow, drying wind, and post-curing ultraviolet (UV) light can be easily introduced into the basket.

The basket 91 includes fixing hooks 92 formed on both sides of a side surface thereof for fixing the basket 91 to the transfer device 200. The fixing hook 92 may be formed in an “L” shape. The fixing hook 92 may be fitted into and mounted in the basket-fixing part 212 of the transfer device 200.

When the basket 91 is mounted on the transfer device 200, the basket 91 may be fixed by the basket-fixing electromagnet 230 so that the basket 91 cannot be removed while the transfer device 200 is moving. In some cases, the basket 91 may be fixed by a separate mechanical fixing device (not illustrated), for example, a snap fit hook.

Proximity sensors 93 and 94 may be provided on an inner or outer surface of the basket 91. The proximity sensors 93 and 94 may detect whether the output 1 has been accommodated. Further, the proximity sensors 93 and 94 may detect whether the basket 91 is mounted on the transfer device 200.

The proximity sensors 93 and 94 may be installed on the outer and the inner surfaces of the basket 91, respectively, to detect the inside and outside of the basket 91, respectively. Further, the proximity sensors 93 and 94 may be installed on both inner surfaces of the basket 91 to detect access toward the outside, or may be installed on both outer surfaces of the basket 91 to detect access to the inside.

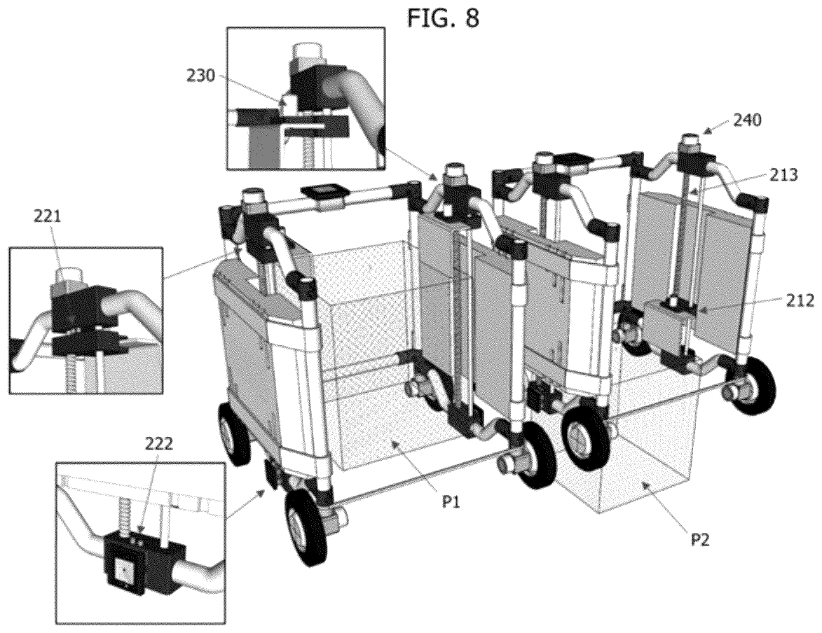

FIG. 8 is a set of diagrams illustrating an example in which the basket of the smart transfer device according to an embodiment of the present invention is mounted.

Referring to FIG. 8, the transfer device 200 includes position sensors 221 and 222 provided at upper and lower portions thereof, respectively, and the basket-fixing electromagnet 230 fixes the mounted basket 91 not to be removed.

The vertical drive motor 240 provides driving force to the basket 91 to move up and down.

In this case, the upper position sensor 221 and the lower position sensor 222 may detect the location of the basket 91.

When the transfer device 200 arrives at the module to perform the work, the main processor of the transfer device 200 stops, and then drives the vertical drive motor 240 to move the basket 91 downward from a first position P1 to a second position P2 about a moving axis 213.

The basket 91 is moved downward by the vertical drive motor 240 and introduced into the module at the second position P2. The basket 91 is introduced into a work bath of the module.

The module performs a post-processing process on the output 1 accommodated in the basket 91. In this case, the basket 91 may be configured in the form of a box with a mesh structure, and a cleaning solution, water, and UV light introduced from the module may be introduced into the basket 91 and reach the output 1.

When the work is completed, the transfer device 200 operates the vertical drive motor 240 to move the basket 91 upward from the second position P2 to the first position P1.

The basket 91 is moved downward or upward by the vertical drive motor 240 in a state in which fixing hooks 92 formed on both sides of the basket 91 are fitted and mounted into the basket-fixing part 212 of the transfer device 200 and are fixed by the basket-fixing electromagnet 230.

That is, the basket-fixing part 212 is moved up and down by the operation of the vertical drive motor 240, and thus the basket 91 fixed to the basket-fixing part 212 move up and down together with the basket-fixing part 212.

The upper position sensor 221 and the lower position sensor 222 may detect the changed location of the basket 91 as the basket 91 moves up and down.

When the movement of the basket 91 is completed, the transfer device 200 may move to a next module.

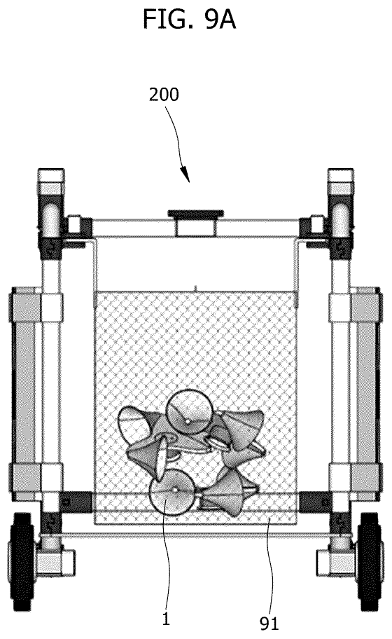

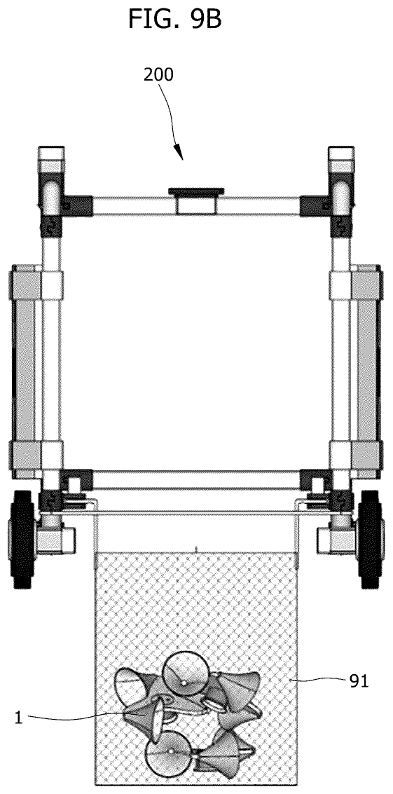

FIGS. 9A and 9B are a set of diagrams illustrating a location of a basket for processing work of a smart transfer device according to an embodiment of the present invention.

Referring to FIG. 9A, a basket 91 is mounted on the transfer device 200 and accommodates an output 1.

Referring to FIG. 9B, the basket 91 moves up and down for a post-processing process while mounted on the transfer device 200.

When the basket 91 moves downward, the output 1 accommodated inside the basket 91 move together with the basket 91.

Accordingly, when the transfer device 200 stops at any one module for the post-processing process and moves to a lower portion of the basket 91, the output 1 accommodated inside the basket 91 may be introduced into a work bath provided inside the module to perform any one task among cleaning, rinsing, drying, and post-curing.

The main processor of the transfer device 200 stops at a process module corresponding to set work and moves to the lower portion of the basket 91 so that the output 1 is introduced into the work bath provided inside the process module. The transfer device 200 repeats such an operation to perform the post-processing work on the output 1.

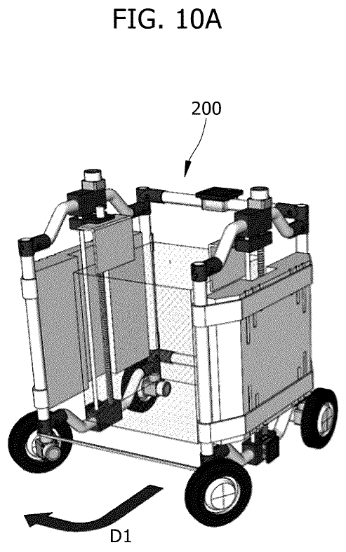

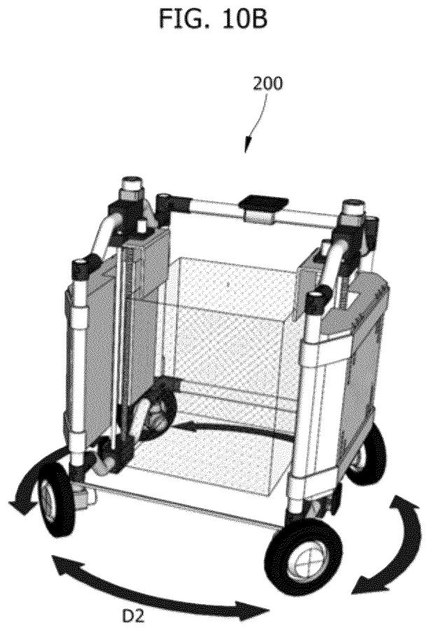

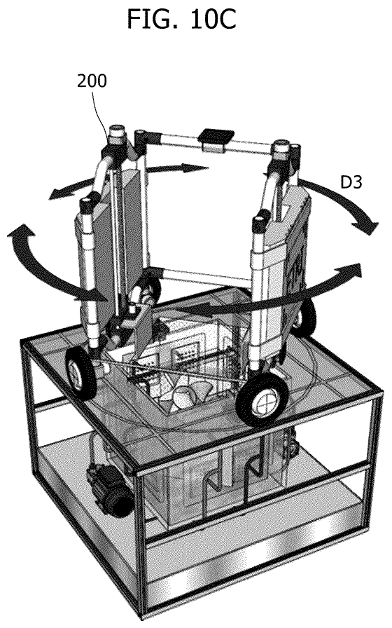

FIGS. 10A to 10C are a set of diagrams referenced to describe a rotational operation of a smart transfer device according to an embodiment of the present invention.

Referring to FIGS. 10A to 10C, the transfer device 200 may be rotated left or right and operated by the rotation motor 282 being operated.

The transfer device 200 may be rotated in place by the rotation motor 282, and thus the transfer device 200 may change its movement direction by rotating in place.

As illustrated in FIG. 10A, the transfer device 200 may change its movement direction to either a left direction or a right direction D1.

As illustrated in FIG. 10B, the transfer device 200 may rotate in place in a direction D2 with respect to the left and right directions. The transfer device 200 may rotate in place using the rotation motors 282 mounted on the wheels.

Therefore, as illustrated in FIG. 10C, the transfer device 200 may change its movement direction to a direction D3 by rotating in place using the rotation motor 282 at an upper portion of a narrow module even while traveling on the upper portion of the module.

Further, the transfer device 200 may rotate in place while performing the post-processing process in the module or while waiting after stopping.

The main processor of the transfer device 200 may receive a request during the post-processing work of the module and rotate in place. Since the basket 91 is fixed to the basket-fixing part 212 of the transfer device 200, when the main body 210 rotates, the basket 91 also rotates.

The main processor of the transfer device 200 may rotate in place around the work bath of the module to rotate the output 1 together with the basket 91.

The transfer device 200 may rotate in one direction or alternately rotate left and right. Further, the transfer device 200 may repeatedly rotate and operate at regular time intervals.

Accordingly, even when the work bath of the module does not rotate, the efficiency of the post-processing work performed on the output 1 may be improved through the rotation of the transfer device 200.

The transfer device 200 may repeat specified rotations according to work variables set by the control device 100.

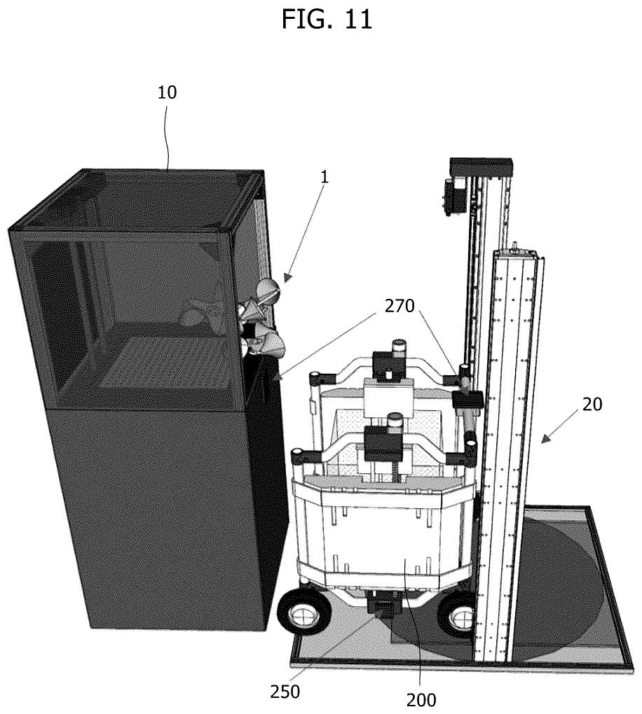

FIG. 11 is a diagram referenced to describe an output reception method of the smart transfer device according to an embodiment of the present invention.

Referring to FIG. 11, in the supply module 20, the transfer device 200 may accommodate the output 1 of the 3D printer 10 in the basket 91.

The transfer device 200 may wirelessly communicate with the 3D printer through the communication devices 250 and 270.

Further, the control device 100 may wirelessly communicate with the 3D printer.

The transfer device 200 may be located in the supply module 20 and receive and store the information about the output 1, such as an ID, a volume, a mass, a thickness, support information, a slicing layer, etc.

The transfer device 200 may transmit the received information of the output 1 to each module. Further, the transfer device 200 may transmit the information of the output 1 to the control device 100.

The control device 100 may set work for a post-processing process to be performed on the basis of the information of the output 1, set work variables for the corresponding work, and set a work path of the transfer device 200.

In some cases, the transfer device 200 may set work for the post-processing process to be performed on the basis of the information of the output 1, set work variables for the corresponding work, and set a work path itself.

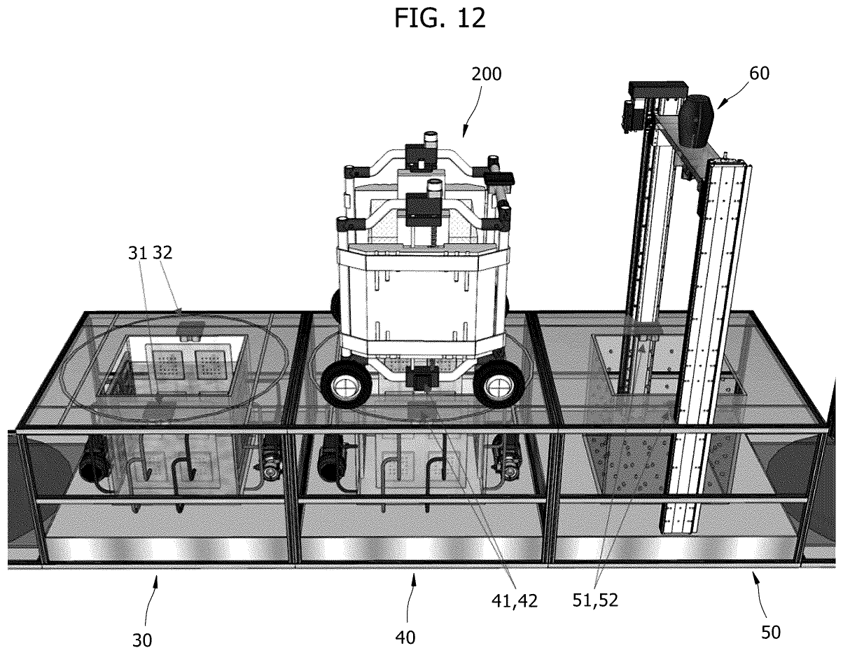

FIG. 12 is a diagram referenced to describe processing work of the smart transfer device according to an embodiment of the present invention.

Referring to FIG. 12, the transfer device 200 wirelessly communicates with the control device 100, which controls and manages work paths and schedules for a plurality of process modules that perform post-processing processes.

The transfer device 200 may transmit or receive information about a current location and movement schedule to or from the control device 100.

The control device 100 may set an operating time, a cleaning solution flow velocity (flow rate), and the number of times the cleaning solution flow direction is changed for the cleaning module 30, and set an operating time, a rinse liquid flow velocity (flow rate), and the number of times the rinse liquid flow direction is changed for the rinsing module 40. Further, the control device 100 may set operating times, hot air intensities, hot air temperatures, and UV intensities for the drying module 60 and the post-curing module 50.

The control device 100 may communicate with the plurality of process modules and transmit the set work variables to each module.

Further, the transfer device 200 may communicate with each module while moving and transmit the current location to the control device 100.

The cleaning module 30, the rinsing module 40, the drying module 60 and the post-curing module 50 include communication devices 31, 41, and 51 for transmitting or receiving information and sensors 32, 42, and 52 for location recognition, respectively.

The transfer device 200 may communicate with the communication device provided in each module while moving between the modules, and determine the current location through the sensor for location recognition.

For example, when the transfer device 200 is located in the rinsing module 40, the current location may be determined through the sensor 42 provided in the rinsing module 40 and the lower position sensor 222.

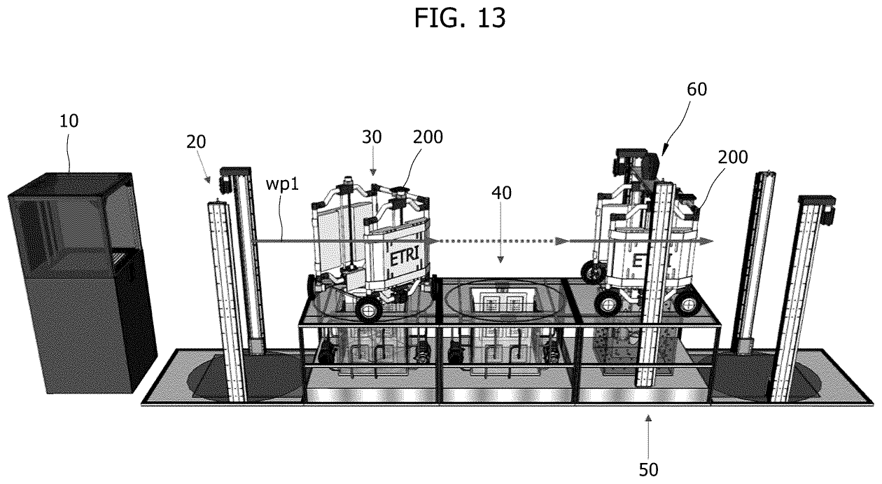

FIG. 13 is a diagram referenced to describe a work path of the smart transfer device according to an embodiment of the present invention.

Referring to FIG. 13, the transfer device 200 moves along a first work path wp1 and stops at a specified module, and then a post-processing process is performed on an output 1.

For example, the first work path wp1 may be set to perform a cleaning process in the cleaning module 30, then skip a rinsing process, and perform a drying process in the drying module 60.

Accordingly, the transfer device 200 stops at the cleaning module 30 and moves the basket 91 downward so that the output 1 is cleaned in a work bath of the cleaning module 30.

When the cleaning process is completed, the transfer device 200 moves the basket 91, then passes the rinsing module 40, and stops at the drying module 60. The transfer device 200 may complete the post-processing process after drying the output 1 in the drying module.

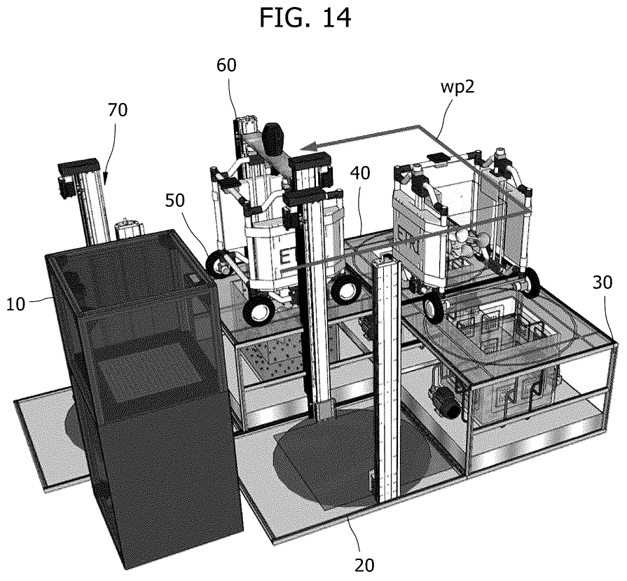

FIG. 14 is a diagram illustrating a configuration of a smart transfer system in which the arrangement of the post-processing process module according to an embodiment of the present invention has been changed.

Referring to FIG. 14, the transfer system may arrange a plurality of process modules in various forms.

Although an example in which a plurality of process modules are arranged in a row has been previously described, the plurality of process modules may be arranged in different forms according to the location of the transfer system, the size of the space, and the number of modules included.

In this case, the transfer device 200 may rotate in place and change the movement direction, and thus a specified post-processing process may be performed on the output 1 while the transfer device 200 moves along a second work path wp2.

The transfer device 200 may change the direction at the cleaning module 30 to move to the rinsing module 40, and change the direction again at the rinsing module 40 to move to the drying and post-curing modules 50 and 60.

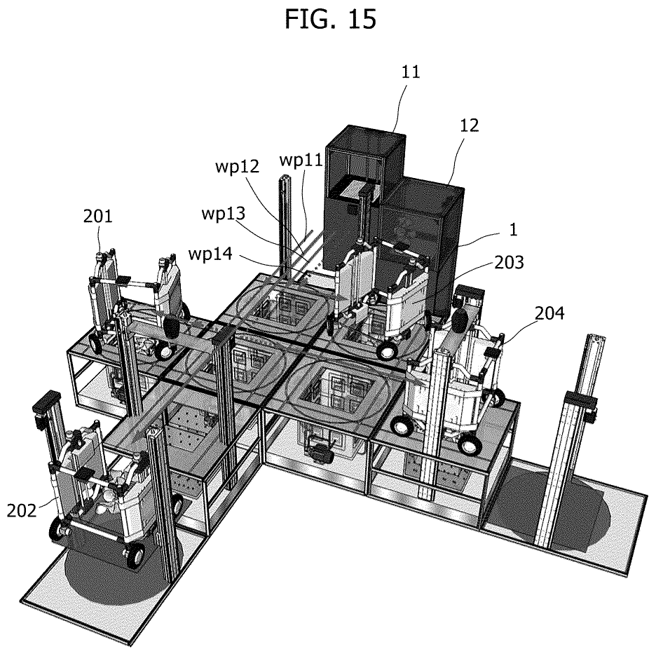

FIG. 15 is a diagram illustrating a configuration of a smart transfer system having a plurality of work paths according to an embodiment of the present invention.

Referring to FIG. 15, the transfer system may include a plurality of process modules and simultaneously perform a post-processing process on a plurality of outputs.

A first transfer device 201 may include a first output and perform the post-processing process on the first output while moving along a third work path wp11.

A second transfer device 202 may include a second output and perform the post-processing process on the second output while moving along a fourth work path wp12.

A third transfer device 203 may include a third output and perform the post-processing process on the third output while moving along a fifth work path wp13.

A fourth transfer device 204 may include a fourth output and perform the post-processing process on the fourth output while moving along a sixth work path wp14.

In this case, the control device 100 may set the work paths and schedules so that the plurality of transfer devices do not collide while moving. Further, the control device 100 sets the schedules so that the plurality of process modules can perform specified work on the first to fourth outputs.

3D printers 11 and 12 may be provided as a plurality of 3D printers.

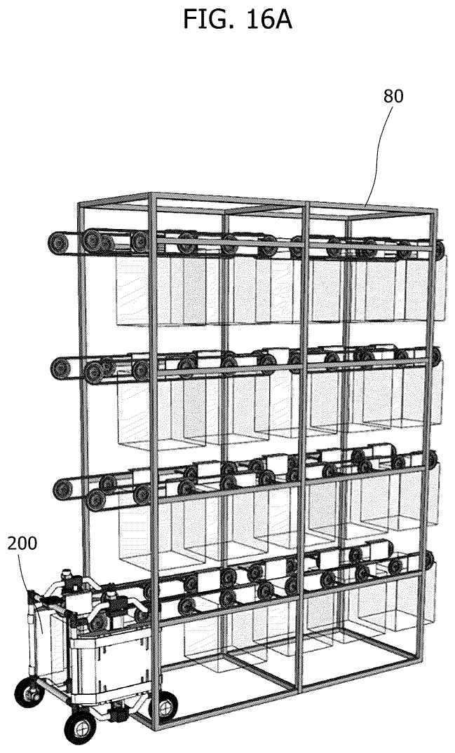

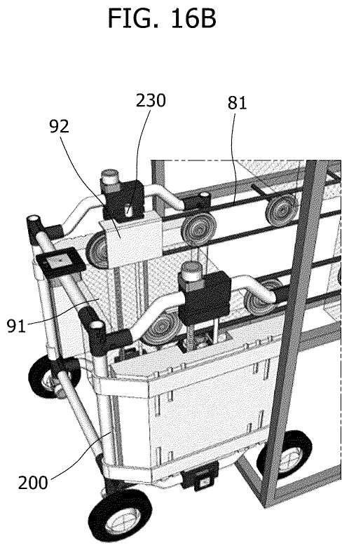

FIGS. 16A and 16B are a set of diagrams illustrating a method of loading an output in the smart transfer device according to an embodiment of the present invention.

Referring to FIG. 16A, when the post-processing process is completed, the transfer device 200 moves to the loading module 80 and moves the basket 91 to the loading module 80 to load the basket 91 into the loading module 80.

Referring to FIG. 16B, the transfer device 200 enters one side of the loading module 80 so that the fixing hooks 92 of the basket 91 are mounted on rails 81 of the loading module 80.

Accordingly, the basket 91 mounted on the transfer device 200 moves to the rails 81 of the loading module 80.

In this case, the main processor of the transfer device 200 may unfix the basket-fixing electromagnet 230.

Accordingly, the output 1 moves together with the basket 91 and is loaded into the loading module 80.

The transfer device 200 may provide information about the loading of the output 1 to the control device 100.

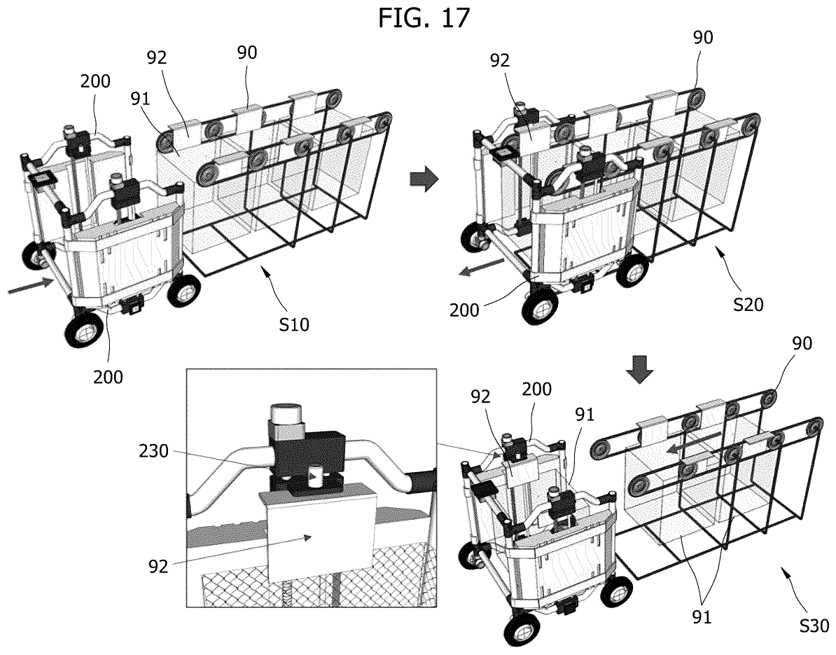

FIG. 17 is a diagram illustrating a method of mounting a basket in the smart transfer device according to an embodiment of the present invention.

Referring to FIG. 17, the transfer device 200 may move to the basket supply module 90 (S10) and mount a new basket on the basket supply module 90.

Baskets 91 without contents are provided in the basket supply module 90.

The transfer device 200 enters one side of the basket supply module 90 so that the fixing hooks 92 of any one of the baskets 91 provided in the basket supply module 90 are inserted into the basket-fixing part 212 (S20).

The main processor of the transfer device 200 fixes the basket 91 using the basket-fixing electromagnet 230 provided at an upper end of the basket-fixing part 212.

The transfer device 200 moves backward and moves together with the newly fixedly basket 91.

When the new basket 91 is mounted, the transfer device 200 may move to the supply module 20 and allow a new output to be accommodated in the basket 91.

Therefore, the smart transfer system and method for performing the 3D printing output post-processing and loading processes according to one aspect of the present invention can effectively perform supplying, cleaning, rinsing, drying, and post-curing processes, which are post-processing processes, using an autonomous robot, continuously and effectively perform transfer of an output to individual processes or between processes, and automatically transfer the output to a loading module.

The smart transfer system and method for performing the 3D printing output post-processing and loading processes according to one aspect of the present invention can rapidly perform a post-processing process by uniformly processing both the post-processing process for 3D printing outputs and a process of loading results thereof using a single mobile transfer device.

The smart transfer system and method for performing the 3D printing output post-processing and loading processes according to one aspect of the present invention can control a transfer device by selecting work to be performed according to a 3D printing output and accordingly, setting a work path and a schedule to improve work efficiency, and can control work progress by adding or modifying the work as necessary.

The smart transfer system and method for performing the 3D printing output post-processing and loading processes according to one aspect of the present invention can improve space efficiency and control a plurality of transfer devices simultaneously to improve efficiency.

While the present invention has been described with reference to embodiments illustrated in the accompanying drawings, the embodiments should be considered in a descriptive sense only, and it should be understood by those skilled in the art that various alterations and other equivalent embodiments may be made. Therefore, the scope of the present invention should be defined by only the following claims.

What is claimed is:

1. A smart transfer system for performing three-dimensional (3D) printing output post-processing and loading processes, comprising:
a transfer device configured to transfer a basket accommodating an output of a 3D printer;
a plurality of process modules configured to perform cleaning, rinsing, drying, and post-curing processes on the output; and
a control device configured to set work to be performed on the basis of information about the output, set a work path of the plurality of process modules according to the work, and control the transfer device to move along the work path.

2. The smart transfer system of claim 1, wherein the control device receives the information about the output from the 3D printer, sets the work path to perform at least one of the cleaning, rinsing, drying, and post-curing processes according to the information about the output, and sets a work variable for the work to be performed to control the plurality of process modules.

3. The smart transfer system of claim 2, wherein the control device communicates with the plurality of process modules, transmits the work variable to the plurality of process modules, and monitors operational states of the plurality of process modules.

4. The smart transfer system of claim 1, wherein the control device communicates with the transfer device, tracks a location of the transfer device, and stores data received from the transfer device.

5. The smart transfer system of claim 1, wherein, when the control device transfers a plurality of outputs using a plurality of transfer devices, the control device sets a schedule for preventing collisions between the plurality of transfer devices and operating the plurality of process modules.

6. The smart transfer system of claim 1, wherein the plurality of process modules further include a vertical movement module that moves the transfer device up and down.

7. The smart transfer system of claim 1, further comprising a loading module configured to load the output,
wherein, when the post-processing process is completed, the transfer device moves to the loading module and moves the basket accommodating the output to the loading module.

8. The smart transfer system of claim 1, further comprising a basket supply module including the basket,
wherein the transfer device loads the basket, then moves to the basket supply module, mounts a new basket on the basket supply module, and accommodates a new output in the new basket.

9. The smart transfer system of claim 1, wherein, when the transfer device stops at any one process module of the plurality of process modules, the transfer device moves the basket downward so that the output accommodated in the basket is introduced into a work bath provided inside the process module.

10. The smart transfer system of claim 9, wherein, in a state in which the output is introduced into the work bath of the process module, the transfer device rotates in place around the process module through a rotation motor so that the output rotates together with the basket.

11. The smart transfer system of claim 10, wherein, in a state in which the output is introduced into the work bath of the process module, the transfer device rotates in place around the process module through the rotation motor so that the output rotates together with the basket.

12. A smart transfer device for performing three-dimensional (3D) printing output post-processing and loading processes, comprising:
a basket-fixing part into which a basket accommodating an output is inserted;
a basket-fixing electromagnet that is provided in the basket-fixing part and fixes the basket;
a vertical drive motor configured to move the basket up and down;
a position sensor configured to detect a location of the basket; and
a main processor configured to communicate with a control device, control the smart transfer device to travel along a specified work path, and allow the basket to be moved up and down through the vertical drive motor.

13. The smart transfer device of claim 12, wherein the main processor allows the basket-fixing part to be moved downward by an operation of the vertical drive motor and allows the basket to be introduced into the process module together with the output so that a post-processing process is performed on the output.

14. The smart transfer device of claim 12, further comprising a rotation motor installed on a wheel,
wherein the main processor drives the rotation motor, and controls the main body to rotate in place around the process module so that the basket rotates inside the process module together with the output.

15. A smart transfer method for performing three-dimensional (3D) printing output post-processing and loading processes, comprising:
moving a transfer device equipped with a basket to a supply module and accommodating, by the transfer device, an output generated from a 3D printer in the basket;
receiving, by a control device, data on the output from the 3D printer;
setting, by the control device, post-processing work to be performed on the basis of the data on the output and setting a work path of the transfer device for the post-processing work; and
moving the transfer device along the work path, stopping at any one process module of a plurality of process modules, and performing, by the transfer device, a post-processing process on the output.

16. The smart transfer method of claim 15, further comprising, when the post-processing process is completed, moving the transfer device to a loading module and loading, by the transfer device, the basket accommodating the output into the loading module.

17. The smart transfer method of claim 15, further comprising:
setting, by the control device, a work variable for a process module to perform the post-processing work;
transmitting, by the control device, the work variable to the process module; and
when the transfer device stops at the process module, operating, by the process module, according to the set work variable and post-processing the output.

18. The smart transfer method of claim 15, wherein the performing of the post-processing process further includes, when the transfer device stops at any one process module of the plurality of process modules, moving the basket downward and introducing the output accommodated in the basket into a work bath provided inside the process module.

19. The smart transfer method of claim 18, wherein the performing of the post-processing process further includes, in a state in which the output is introduced into the work bath of the process module, rotating the transfer device in place around the process module through a rotation motor so that the output rotates together with the basket.

20. The smart transfer method of claim 15, wherein, in the setting of the work path of the transfer device, when the transfer device is provided as a plurality of transfer devices, the control device sets a plurality of work paths to prevent collisions between the plurality of transfer devices and sets a schedule for operating the plurality of process modules.
